(19) United States
(12) Patent Application Publication
(10) Pub. No.: US 2011/0122136 A1
(43) Pub. Date: May 26, 2011

(54) METHOD AND APPARATUS FOR FILTERING VECTOR OBJECT'S CONTROL POINTS

(75) Inventor: Sang-beom JO, Seoul (KR)

(73) Assignee: Samsung Electronics Co., Ltd., Suwon-si (KR)

(21) Appl. No.: 12/822,346

(22) Filed: Jun. 24, 2010

(30) Foreign Application Priority Data
Nov. 24, 2009 (KR) 10-2009-0114062

(51) Int. Cl. G06T 17/00

(52) U.S. Cl. 345/428

(57) ABSTRACT

Provided are an apparatus and a method of filtering control points of a vector object, the method including: setting at least one parameter value in order to adjust a number of control points in the vector object; receiving a user's selection of a predetermined region of the vector object; and increasing or reducing a number of control points in the selected region by using the set parameter value.

### CROSS-REFERENCE TO RELATED PATENT APPLICATION

This application claims priority from Korean Patent Application No. 10-2009-0114062, filed on Nov. 24, 2009 in the Korean Intellectual Property Office, the disclosure of which is incorporated herein in its entirety by reference.

### BACKGROUND

1. Field

Apparatuses and methods consistent with the exemplary embodiments relate to an apparatus and method of filtering control points of a vector object, and more particularly, to an apparatus and method of selecting a predetermined region of a vector object by using a brush-based interface and controlling the number of control points of the vector object in the selected region.

2. Description of the Related Art

Recently, as production of vector image contents requiring a low capacity has increased, various tools to produce vector images have been used. In particular, low capacity vector images have been produced by controlling vector objects forming the vector images.

A vector object refers to a shape of a picture forming a vector image. Vector objects are separate from or combined with each other to represent the vector image. One vector object consists of control points and lines. When vector images are produced, it is necessary to control the control points of the vector objects.

When the number of control points of the vector object is adjusted, various effects may be represented. If the number of control points of the vector object is increased, image quality may be improved when rendering each vector image, and curves may be processed easily due to a division of lines connecting the control points. On the other hand, if the number of control points of the vector object is reduced, although image quality is degraded when rendering the vector images, rendering speed may be increased and a capacity required to store vector images may be reduced since the number of control points processed by a vector graphic engine is reduced. Therefore, a technology that may improve performances of processing vector images without visibly lowering the quality of the vector images is required.

### SUMMARY

The exemplary embodiments provide an apparatus and method of filtering control points of vector objects by selecting a predetermined region of a vector object by using a brush-based interface and adjusting the number of control points of the vector object within the selected region, and a computer readable recording medium in which a program for executing the method is recorded.

According to an aspect of an exemplary embodiment, there is provided a method of filtering control points of a vector object, the method including: setting at least one parameter value in order to adjust a number of control points in the vector object; receiving a user's selection of a region of the vector object; and increasing or reducing the number of control points in the selected region by using the set parameter value.

The receiving the user's selection of the region may include determining the region according to a size, a shape, and a moving path of a brush.

The number of control points in the selected region may be increased or reduced while the brush moves.

The method may further include: displaying a menu for the setting the at least one parameter value; and setting the at least one parameter value by using the displayed menu, wherein the at least one parameter value may include at least one of information about the brush used to select the region, an increase or a reduction of the control points, a control point filtering intensity, and a user edge detection option.

The increasing or reducing the number of control points may include increasing or reducing the number of control points while maintaining a curvature between the control points included in the selected region or minimizing a change in the curvature.

The increasing or reducing the number of control points may include, when there exist control points included in a boundary of the vector object in the selected region, adding control points in the boundary around the selected region to the selected region.

According to an aspect of another exemplary embodiment, there is provided an apparatus which filters control points of a vector object, the apparatus including: a user input unit which receives at least one parameter used to adjust a number of control points in the vector object and which receives a user's selection of a region in the vector object to which the at least one parameter is to be applied; a controller which increases or reduces the number of control points in the selected region by using the at least one parameter; and a rendering unit which renders the vector object, in which the number of control points is increased or reduced.

### BRIEF DESCRIPTION OF THE DRAWINGS

The above and other features and advantages will become more apparent by describing in detail exemplary embodiments thereof with reference to the attached drawings in which:

FIG. 1 is a schematic block diagram of an apparatus which filters control points of vector objects, according to an exemplary embodiment;

FIG. 2 is a flowchart illustrating a method of filtering control points of vector objects, according to an exemplary embodiment;

FIG. 3 is a diagram showing a filtering menu for inputting information used to filter the control points of the vector objects, according to an exemplary embodiment;

FIGS. 4A through 4C are diagrams illustrating processes of filtering the control points of the vector objects with respect to a two-dimensional (2D) vector image, according to an exemplary embodiment;

FIGS. 5A through 5C are diagrams illustrating processes of filtering the control points of the vector objects with respect to a three-dimensional (3D) vector image, according to an exemplary embodiment; and

FIGS. 6A through 6C are diagrams illustrating processes of filtering control points existing on a boundary between vector objects, according to an exemplary embodiment.

### DETAILED DESCRIPTION OF THE EXEMPLARY EMBODIMENTS

The exemplary embodiments will now be described more fully with reference to the accompanying drawings. In the drawings, the thicknesses of layers and regions are exaggerated for clarity. Like reference numerals in the drawings denote like elements, and thus their description will be omitted. Expressions such as “at least one of,” when preceding a list of elements, modify the entire list of elements and do not modify the individual elements of the list.

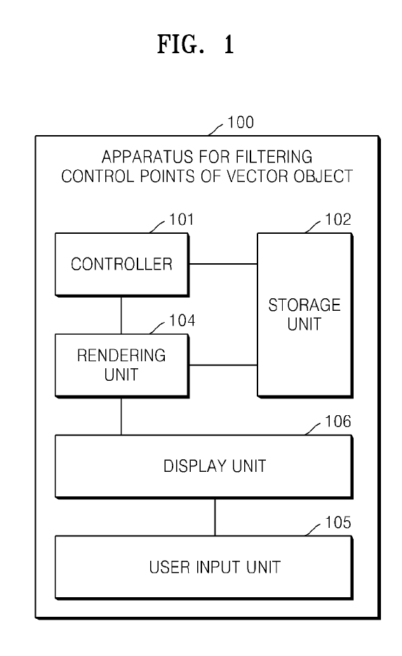

FIG. 1 is a schematic block diagram of an apparatus 100 which filters control points of vector objects, according to an exemplary embodiment. The apparatus 100 which filters control points of vector objects includes a vector image controller 101, a rendering unit 104, and a user input unit 105, and may further include a storage unit 102 and a display unit 106.

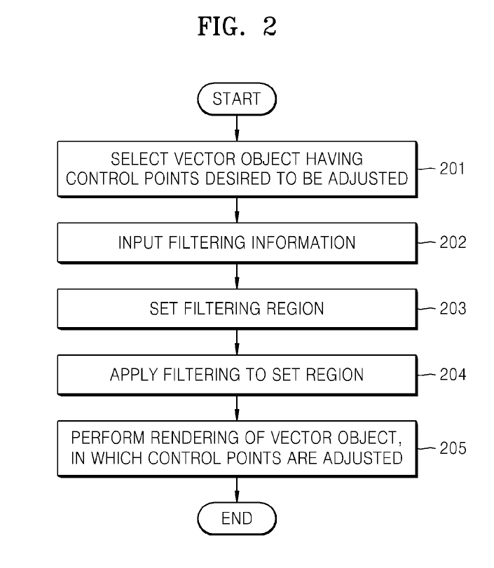

The vector image controller 101 performs overall operations of controlling vector image data. The vector image controller 101 receives information for filtering control points of vector objects and information about a predetermined region of a vector image from the user input unit 105, analyzes locations and the number of control points in the predetermined region, and adjusts the locations and the number of control points according to the analyzing result. Operations of the vector image controller 101 will be described in more detail later with reference to FIG. 2.

The storage unit 102 stores an application program producing a vector image and information about the vector image. The vector image includes one or more vector objects, and information about the vector objects is stored in a hierarchical structure. The vector image controller 101 reads the information about the vector objects from the storage unit 102 for adjusting the control points of the vector objects, performs a filtering operation, and stores the vector objects, to which the filtering operation is applied, in the storage unit 102. The storage unit 102 may store the application program for producing the vector image and the data related to the vector image in separate storage devices.

The rendering unit 104 reads the vector objects relating to the vector image from the storage unit 102 and performs a rendering operation of the vector objects in order to output the vector image to the display unit 106.

The user input unit 105 is a device which receives information used to adjust the number of control points of the vector object and information about the predetermined region, the control points of which are to be adjusted, from the user. For example, the user input unit 105 may include a device such as a keyboard, a mouse, one or more buttons, a rotatable dial, a touch screen, etc.

The display unit 106 displays a final image output from the rendering unit 104, and may display only the vector image or the vector objects of the vector image, control points, and lines between the control points with the vector image according to an option set by the user. A liquid crystal display (LCD), an organic light emitting diode (OLED) display, a light emitting diode (LED) display, or a plasma display panel may be used as the display unit 106, though it is understood that the exemplary embodiments are not limited thereto.

FIG. 2 is a flowchart illustrating a method of filtering control points of vector objects, according to an exemplary embodiment. Referring to FIG. 2, in operation 201, the user selects a vector object, control points of which he or she wants to adjust, and inputs the selection to the apparatus 100. The selection of the vector object may be performed by using the user input unit 105, and one or more vector objects may be selected.

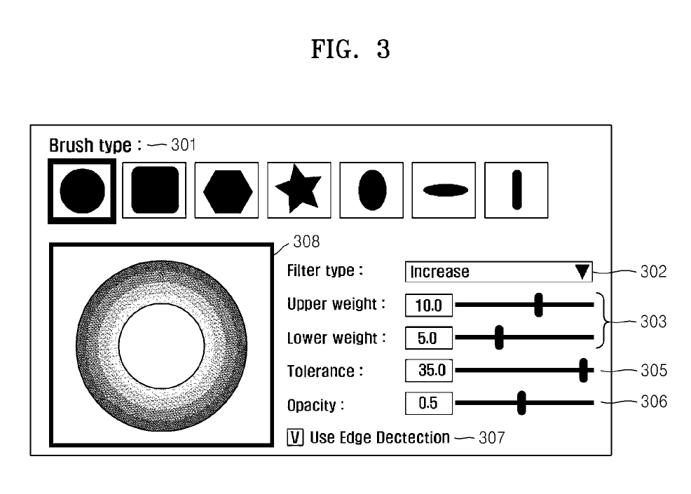

In operation 202, the user may input at least one parameter value as information used to perform the filtering of control points in the vector object selected in operation 201. The information used in the filtering of control points may be input via a filtering menu. FIG. 3 shows an example of the filtering menu, according to an exemplary embodiment, and the user may set parameter values used to perform the filtering of control points by using the filtering menu.

Referring to FIG. 3, parameters used in the filtering of the control points may include a brush type 301, a filter type 302, a weight 303, a tolerance 305, an opacity 306, and a user edge detection 307. However, the above parameters are merely exemplary, that is, some of the above parameters may be used or other parameters may be used in another exemplary embodiment. In addition, the filtering may be performed with default values without the user setting the parameter values.

The brush type 301 is to designate a brush shape that is used to select a region to which the filtering operation is applied, and may include a circle, a square, a hexagon, a star, and an oval. However, an exemplary embodiment is not limited to the above examples. The selected brush shape is displayed on the vector object on the display unit 106 to help the user select the region.

The filter type 302 is used to designate a type of filtering of the control points, and may be set as control point reduction or control point increase. The control point increase property denotes a filtering type for adding new control points between adjacent control points in order to increase the number of control points. The control point reduction property denotes a filtering type for generating new control points, the number of which does not exceed the number of control points existing in the selected region. Here, the existing control points may be used as a part of the newly generated control points.

The weight 303 is used to designate an application range of the brush, that is, a brush area, and may include an upper weight and a lower weight. The upper weight sets an uppermost value of a brush radius, and the lower weight sets a lowermost value of the brush radius. Referring to FIG. 3, the upper weight is set as 10.0 and the lower weight is set as 5.0, which indicates that a region on which a part of the brush, that is, from 5.0 to 10.0 of the radius, passes through, is set as the filtering region.

The tolerance 305 is used to adjust a filtering level. As the filtering level is increased, an application intensity of the filtering is increased, and as the filtering level is reduced, the application intensity of the filtering is reduced. In FIG. 3, when the highest filtering level is assumed to be 100%, it is set to perform the filtering at a level of 35%.

The opacity 306 is used to designate a damping ratio of the brush area. The filtering intensity in the brush area is gradually damped from the point set by the upper weight to the point set by the lower weight. That is, the filtering intensity is the highest at a portion corresponding to the upper weight and the lowest at a portion corresponding to the lower weight. The opacity 306 determines the filtering intensity with the tolerance 305. For example, if the opacity 306 value is 1.0, the tolerance 305 value is determined as the filtering intensity, and if the opacity 306 is smaller than 1.0, the filtering intensity is gradually reduced to the lower weight according to a ratio of the opacity value.

The user edge detection 307 is used to prevent gaps from being generated on the boundaries between the vector objects when a plurality of vector objects are simultaneously filtered. When the user edge detection 307 is selected, distances between the control points are detected, and the locations of the control points are adjusted in order to prevent the gap from being generated between two different vector objects.

Referring to FIG. 3, a brush preview image 308 representing the shape and size of the brush, the brush area, and the filtering intensity which are set by the current parameter values is shown on a lower left portion.

Referring back to FIG. 2, operation 202 in which the filtering parameters are set may be performed before performing operation 201 in which the predetermined region of the vector object is selected. If operation 202 is performed earlier, the parameter properties set in operation 202 are applied to the vector object upon being selected in operation 201.

In operation 203, a region to which the filtering operation will be applied is designated via the user input unit 105. For example, the user may select the region to be filtered in the vector object selected in operation 201 by using the user input unit 105 (e.g., the mouse or the keyboard), or by using the brush set in operation 202. If the user selects the region by using the brush, the filtering region may be determined according to the size, shape, and moving path of the brush. The user may move the mouse up and down or from left to right to move the brush, and thus, the filtering set by the filtering parameters may be applied to the control points included in the brushed area. Here, the filtering information about the region over which the brush passes repeatedly is increased by as much as the repetition, and thus, the filtering may be repeatedly applied. That is, the filtering is repeatedly performed by as many times as the number of brushings. When the mouse is moved up and down or from left to right, the brushed area is filtered, and the filtering is finished when the mouse is stopped.

In operation 204, the filtering is applied to the brushed area, and the filtering is performed according to the parameters set in operation 202. The filtering may be performed after the filtering region is selected by the brush. However, in another exemplary embodiment, the filtering may be performed in real-time, that is, simultaneously with the movement of the brush.

When the filter type is set as the control point increase, additional control points are inserted between the control points included in the vector object of the brushed area. In this case, the additional control points are inserted while maintaining a curvature between the existing control points or minimizing a change in the curvature.

When the filter type is set as the control point reduction, one or more existing control points are removed, and then, a new control point is added, while maintaining the curvature between the existing control points or minimizing the change in the curvature.

When the filter type is set as the control point reduction and the user edge detection is selected, it is analyzed whether the control points included in the brushed area exist on a boundary of the vector object including corresponding control points. If the selected region includes the control points which exist on the boundary of the vector object, some control points included in the boundary around the selected region are added to the selected region. That is, in a case of the control points included in the boundary, the peripheral control points included in the boundary are additionally included in the selected region by using the brush. Due to the above operation, when the control points existing on the boundary between a plurality of vector objects are filtered, locations of the control points of different vector objects may be synchronized on the boundary, and thus, generating of gaps between the vector objects may be reduced.

In addition, when the filter type is set as the control point reduction, an operation of analyzing whether the control points included in the region, to which the filtering is applied, may be represented by unit geometry, may be additionally performed. If the control points may be represented by the unit geometry, the control points are represented by the unit geometry. If the control points may not be represented by the unit geometry, locations of the control points are adjusted based on the tolerance, and after that, the control points included in a critical value range may be combined as one control point to be represented.

In operation 205, at least one vector object, the control points of which are adjusted, is rendered to be displayed as one combined image on the display unit 105.

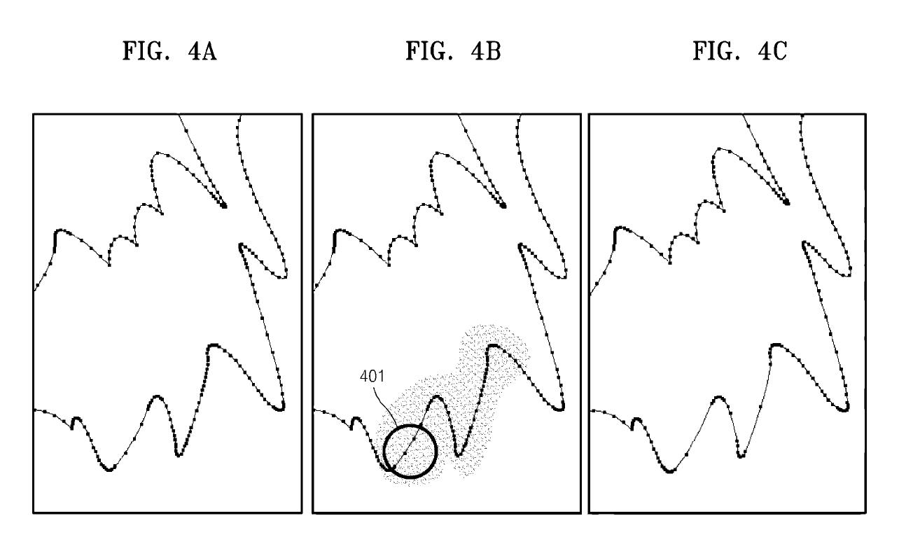

FIGS. 4A through 4C show processes of filtering the control points of a vector object in a two-dimensional (2D) vector image, according to an exemplary embodiment. FIG. 4A shows a vector object before the control points are filtered, FIG. 4B shows an example of selecting a filtering region by using a brush 401, and FIG. 4C shows the vector object after performing the filtering of control points. Referring to FIG. 4C, control points in a region selected in FIG. 4B (dark region) are adjusted, that is, the number of control points is reduced.

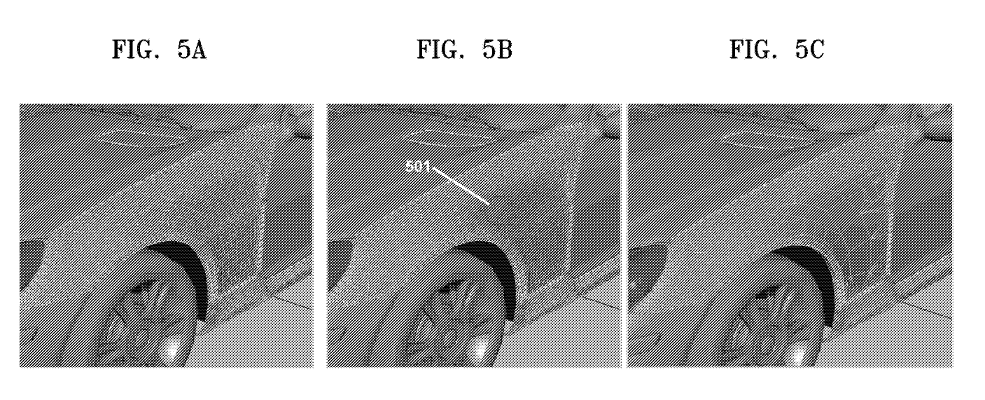

FIGS. 5A through 5C show processes of filtering control points of a vector object in a three-dimensional (3D) image, according to an exemplary embodiment. FIG. 5A shows a vector object before the control points are filtered, FIG. 5B shows an example of selecting a filtering region by using a brush 501, and FIG. 5C shows the vector object after performing the filtering of control points. Referring to FIG. 5C, control points in a region selected in FIG. 5B (dark portion) are adjusted, that is, the number of control points is reduced.

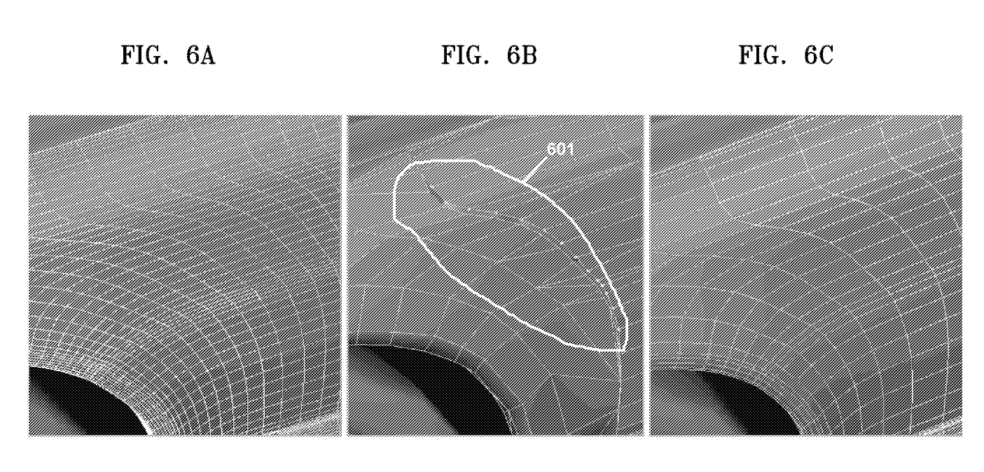

FIGS. 6A through 6C show processes of filtering control points existing on a boundary between vector objects, according to an exemplary embodiment. FIG. 6A shows vector objects before control points of the vector objects are filtered, FIG. 6B shows a gap 601 between boundaries of the vector objects as a result of performing the filtering operation without selecting the user edge detection, and FIG. 6C shows a result of performing the filtering operation after selecting the user edge detection.

According to the exemplary embodiments, the number of control points may be adjusted rapidly and intuitively by using a user interface based on a brush, and the control points of a local area of the vector image may be adjusted, thereby improving the filtering performance and minimizing image quality degradation.

The exemplary embodiments can also be embodied as computer readable codes on a computer readable recording medium. The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. The computer readable recording medium can also be distributed over network coupled computer systems so that the computer readable code is stored and executed in a distributed fashion.

While the present inventive concept has been particularly shown and described with reference to exemplary embodiments thereof, it will be understood by those of ordinary skill in the art that various changes in form and details may be made therein without departing from the spirit and scope of the present invention as defined by the following claims. For example, the apparatus which filters control points of a vector object may further include a bus coupled to each of the units shown in FIG. 1, at least one processor coupled to the bus, and memories that are coupled to the bus in order to store commands, receive messages, or generate messages and coupled to the at least one processor for executing the commands.

What is claimed is:

1. A method of filtering control points of a vector object, the method comprising:
setting at least one parameter value in order to adjust a number of control points in the vector object;
receiving a user's selection of a region of the vector object; and
increasing or reducing the number of control points in the selected region by using the set parameter value.

2. The method of claim 1, wherein the receiving the user's selection of the region comprises determining the region according to a size, a shape, and a moving path of a brush.

3. The method of claim 2, wherein the increasing or reducing the number of control points in the selected region comprises increasing or reducing the number of control points in the selected region while the brush moves.

4. The method of claim 1, further comprising:
displaying a menu for the setting the at least one parameter value; and
setting the at least one parameter value by using the displayed menu,
wherein the at least one parameter value comprises at least one of information about a brush used to select the region, an increase or a reduction of the control points, a control point filtering intensity, and a user edge detection option to prevent gaps from being generated on boundaries between a plurality of vector objects when the plurality of vector objects are simultaneously filtered.

5. The method of claim 1, wherein the increasing or reducing the number of control points comprises increasing or reducing the number of control points while maintaining a curvature between the control points included in the selected region or minimizing a change in the curvature.

6. The method of claim 1, wherein the increasing or reducing the number of control points comprises, when the control points in the selected region have corresponding control points included in a boundary of the vector object around the selected region, adding the corresponding control points in the boundary around the selected region to the selected region.

7. The method of claim 1, wherein the increasing or reducing the number of control points comprises removing a gap between the selected region of the vector object and an adjacent vector object.

8. The method of claim 1, wherein the increasing or reducing the number of control points comprises:
determining whether the control points included in the selected region are representable by a geometry unit;
in response to the control points being determined to be representable by the geometry unit, representing the control points by the geometry unit.

9. A computer readable recording medium having embodied thereon a computer program for executing a method of filtering control points of a vector object, the method comprising:
setting at least one parameter value in order to adjust a number of control points in the vector object;
receiving a user's selection of a region of the vector object; and
increasing or reducing the number of control points in the selected region by using the set parameter value.

10. An apparatus which filters control points of a vector object, the apparatus comprising:
a user input unit which receives at least one parameter used to adjust a number of control points in the vector object and which receives a user's selection of a region of the vector object to which the at least one parameter is to be applied;
a controller which increases or reduces the number of control points in the selected region by using the at least one parameter; and
a rendering unit which renders the vector object, in which the number of control points is increased or reduced.

11. The apparatus of claim 10, wherein the controller determines the region according to a size, a shape, and a moving path of a brush.

12. The apparatus of claim 11, wherein the controller increases or reduces the number of control points in the selected region while the brush is moved on the region.

13. The apparatus of claim 10, further comprising a display unit which displays a menu for setting the at least one parameter,
wherein the at least one parameter comprises at least one of information about a brush used to select the region, an increase or a reduction of the control points, a control point filtering intensity, and a user edge detection option to prevent gaps from being generated on boundaries between a plurality of vector objects when the plurality of vector objects are simultaneously filtered.

14. The apparatus of claim 10, wherein the controller increases or reduces the number of control points while maintaining a curvature between the control points included in the selected region or minimizing a change in the curvature.

15. The apparatus of claim 10, wherein when the control points in the selected region have corresponding control points included in a boundary of the vector object around the selected region, the controller adds the corresponding control points in the boundary around the selected region to the selected region.
